(19) United States
(12) Patent Application Publication
(10) Pub. No.: US 2009/0214795 A1
(43) Pub. Date: Aug. 27, 2009

(54) COATING MASSES COMPRISING 2,4'-DIISOCYANATODIPHENYLMETHANE

(75) Inventors: Carl Jokisch, Mannheim (DE); Eva Wagner, Bad Dürkheim (DE); Harald Schaefer, Mannheim (DE); Thomas Zech, Bobenheim-Roxheim (DE); Bernd Bruchmann, Freinsheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/994,128

(22) PCT Filed: Jun. 23, 2006
(86) PCT No.: PCT/EP2006/063492

§ 371 Date: Sep. 5, 2008

(30) Foreign Application Priority Data
Jun. 28, 2005 (DE) 102005030500.8

(51) Int. Cl. B05D 3/02; C08L 75/04

(52) U.S. Cl. 427/388.1; 524/589; 524/590; 427/385.5; 427/389; 427/389.7; 427/391; 427/389.9

(57) ABSTRACT

The present invention relates to coating compositions which comprise 2,4′-diisocyanatodiphenylmethane, to processes for preparing them, and to their use.

The present invention relates to coating compositions which comprise 2,4′-diisocyanatodiphenylmethane, to processes for preparing them, and to their use.

The use of isocyanates, and particularly aromatic isocyanates, in coating compositions is widespread.

Examples of typical aromatic isocyanates include tolylene 2,4-diisocyanate, tolylene 2,4- and 2,6-diisocyanate (TDI) isomer mixtures, and isomer mixtures of 2,4′- and 4,4′-diisocyanatodiphenylmethane (MDI) and also 2,4′- and 4,4′-MDI in combination with higher-oligomer MDI grades (polymeric MDI). Of these, however, TDI has a strong toxicity and exhibits a significant vapor pressure even at room temperature.

Industrial synthesis of diisocyanatodiphenylmethane (MDI) produces an isomer mixture of 4,4′-MDI and 2,4′-MDI, and, if appropriate, 2,2′-MDI. This mixture is typically distilled and/or crystallized to yield pure 4,4′-MDI and also a mixture of approximately 50% to 80% 4,4′-MDI and approximately 20% to 50% 2,4′-MDI. Pure 2,4′-MDI has only recently become industrially available.

DE-A1 4136490 describes the use of aromatic isocyanates, the disclosure encompassing lists which include MDI isomer mixtures having a 2,4′ isomer content of at least 90%, in adhesives and coating compositions, prepolymers being prepared by reacting the aromatic isocyanates in a superstoichiometric NCO:OH ratio with hydroxyl groups. These isocyanates are prepared solventlessly and employed with direct application to the substrate.

EP-A1 693511 likewise describes the use of 2,4′-MDI in one-component, solvent-free hotmelt adhesives (hotmelts), the stoichiometry in the preparation of prepolymers being even higher than in DE-A1 4136490.

WO 99/50329 describes aqueous polyurethane latices which may comprise a series of aromatic isocyanates. Although 2,4′-MDI is recited as part of long lists, the only explicit disclosure in the applications is of a 50:50 mixture of 2,4′- and 4,4′-MDI and also of a highly enriched 4,4′-MDI in the latices.

US 2002/0119321 discloses coating compositions which can comprise diisocyanates. Recited are pure 4,4′- and 2,4′-MDI and also modified MDI prepolymers. The Mondur® MA-2903 from Bayer Corp. that is recited in the examples is a modified 4,4′-MDI derivative; Mondur® MR Light is a 2,4′/4,4′ isomer mixture. Applications comprising pure 2,4′-MDI are not explicitly disclosed.

WO 03/033562 discloses room temperature-solid reaction products of purified 2,4′-MDI with polyols for use in one-component adhesives. These are adhesives which are solid at room temperature (softening point above 23° C.) and applied in the form of their melt as an adhesive, the polymeric constituents of the polyurethane hotmelt adhesives comprising urethane groups and also reactive isocyanate groups. Here too, then, isocyanate groups are used superstoichiometrically. The operation of curing associated with adhesives of this kind containing isocyanate groups is a moisture cure, in which isocyanate groups react with atmospheric humidity and in that way lead to curing of the adhesive.

For the purpose of application it is necessary to melt the hotmelt adhesives (at 130° C., for example), which even at these temperatures are still of high viscosity, and so cannot be used as a coating composition. Reducing the viscosity by admixing solvent is prohibited, since these solvents boil at the high temperatures required, and are unable to evaporate from between bonded substrates. Moreover, in this case a moisture curing mechanism is operated which needs a long time for full cure.

It was an object of the present invention to develop new, easily preparable coating compositions which are liquid at room temperature, comprise aromatic isocyanates, and exhibit good coating properties.

This object has been achieved by means of coating compositions comprising
(a) a mixture of 2,4′-diisocyanatodiphenylmethane (MDI) and 4,4′-diisocyanatodiphenylmethane (MDI), and, if appropriate, 2,2′-diisocyanatodiphenylmethane (MDI), comprising the 2,4′-MDI isomer to an extent of at least 90% by weight,
(b) if appropriate, at least one other di- or polyisocyanate,
(c) at least one compound having at least two isocyanate-reactive groups,
(d) if appropriate, at least one further compound having an isocyanate-reactive group,
(e) at least one solvent,

the ratio of isocyanate groups (a) to isocyanate-reactive groups from (c) and (d) amounting (in toto) to less than 1.05:1

and, if at least one compound (b) is present, the ratio of isocyanate groups in (a) and (b) (in toto) to isocyanate-reactive groups from (c) and (d) (in toto) amounting to not more than 1.3:1.

At the temperature of application the coating compositions of the invention have a low viscosity and the coatings obtained therewith exhibit good hardness.

The coating compositions are liquid at room temperature (23° C.).

The term “coating composition” is used here synonymously with the term “coating material”, defined by DIN 971-1, and describes liquid product which, when applied to a substrate, produces a coating having protective, decorative and/or other specific properties.

The structural component (a) in accordance with the invention is a mixture of 2,4′-diisocyanatodiphenylmethane (MDI) and 4,4′-diisocyanatodiphenylmethane (MDI), and, if appropriate, 2,2′-diisocyanatodiphenylmethane (MDI), in which the 2,4′-MDI isomer is comprised to an extent of at least 90% by weight, preferably at least 95% by weight, more preferably at least 97% by weight, and very preferably at least 97.5% by weight. Where this specification uses the term “2,4′-MDI” or “pure 2,4′-MDI” the reference is to the here-identified mixture having the above-specified 2,4′-MDI fractions.

In one preferred embodiment the fraction of 2,2′ isomers in MDI employed is less than 0.3% by weight of the MDI employed; more preferably the MDI composition comprises less than 0.1% by weight and more preferably less than 0.06% by weight of the 2,2′ isomer of MDI.

It is possible in accordance with the invention to use the 2,4′-MDI in monomeric form or as an isocyanurate, biuret, allophanate or uretdione, but preferably in monomeric form.

Allophanates can be formed with saturated or unsaturated, branched or straight-chain, aliphatic, cycloaliphatic or aromatic alcohols.

A further preferred embodiment of the present invention is to convert the 2,4′-MDI, before use in a coating composition of the invention, into an isocyanate group-containing urethane. For that purpose, before being used in the coating composition, the 2,4′-MDI is reacted with at least one diol or polyol (c1) to give the corresponding urethane, the number-average molar weight Mₙ of these urethanes remaining preferably below 4000 g/mol, more preferably below 3000, very preferably below 2000 g/mol, in particular below 1500, and especially below 1000 g/mol. Starting, therefore, from an n-valent diol or polyol (c1), by reaction with at least n equivalents of 2,4′-MDI, it is predominantly the urethanes of the first stage that are formed, which are then used preferentially in the coating compositions of the invention. Here, n can adopt values from 2 to 6, preferably from 3 to 6, more preferably from 3 to 4, and very preferably 3. Preference is given to choosing reaction conditions under which the 2,4′-MDI reacts predominantly with one isocyanate group, more preferably predominantly with the isocyanate group in position 4 on the aromatic ring. The idealized product in this case is an oligourethane having n free isocyanate groups.

Typically in that case at least 70 mol % of the isocyanate groups converted into a urethane group are those in position 4 on the aromatic ring, preferably at least 75 mol %, and more preferably at least 80 mol %, with very particular preference at least 85 mol %, and in particular 90 mol %.

Preferred diols and polyols (c1) are ethylene glycol, 1,2-propanediol, 1,3-propanediol, 1,1-dimethylethane-1,2-diol, 2-butyl-2-ethyl-1,3-propanediol, 2-ethyl-1,3-propanediol, 2-methyl-1,3-propanediol, neopentyl glycol, neopentyl glycol hydroxypivalate, 1,2-, 1,3- or 1,4-butanediol, 1,6-hexanediol,1,10-decanediol, bis(4-hydroxycyclohexane)isopropylidene, tetramethylcyclobutanediol, 1,2-, 1,3- or 1,4-cyclohexanediol, cyclooctanediol, norbornanediol, pinanediol, decalindiol, 2-ethyl-1,3-hexanediol, 2,4-diethyloctane-1,3-diol, hydroquinone, bisphenol A, bisphenol F, bisphenol B, bisphenol S, 2,2-bis(4-hydroxycyclohexyl)propane, 1,1-, 1,2-, 1,3-, and 1,4-cyclohexanedimethanol, 1,2-, 1,3- or 1,4-cyclohexanediol, polyTHF having a molar mass of between 162 and 2000, poly-1,2-propanediol or poly-1,3-propanediol having a molar mass of between 134 and 10 000, preferably 134 to 5000, and more preferably 134 to 2000, or polyethylene glycol, and also mixed polyethylene/propylene glycols in the form of copolymers, it being possible for the 1,2-ethylene and 1,2-propylene units to be incorporated randomly or blockwise into the copolymer, having a molar mass of between 106 and 10 000, preferably 134 to 5000, and more preferably 134 to 2000, 1,2-, 1,3- or 1,4-cyclohexanediol, 1,1-, 1,2-, 1,3-, and 1,4-cyclohexanedimethanol, cyclooctanediol, norbornanediol, trimethylolbutane, trimethylolpropane, trimethylolethane, pentaerythritol, glycerol, ditrimethylolpropane, dipentaerythritol, sorbitol, mannitol, diglycerol, threitol, erythritol, adonitol (ribitol), arabitol (lyxitol), xylitol, dulcitol (galactitol), maltitol, tris(hydroxymethyl) isocyanurate or tris(hydroxyethyl) isocyanurate (THEIC). It will be appreciated that mixtures of the alcohols specifed are also suitable.

Preferred compounds (c1) are trimethylolpropane, glycerol, pentaerythritol, dipentaerythritol or 2,2-bis(4-hydroxycyclohexane)propane, each of which may if appropriate also be ethoxylated and/or propoxylated, preferably ethoxylated, one to ten times per hydroxyl group, preferably one to five times, and more preferably one to three times per hydroxyl group.

The diol or polyol (c1) used preferably has a molar mass of up to 400 g/mol, more preferably up to 350, very preferably up to 310, in particular up to 270, and especially up to 200 g/mol.

The present invention with particular advantage provides polyurethanes of the following formula

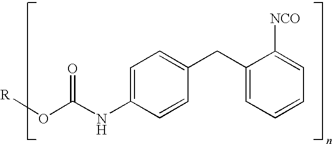

in which

n is a positive integer from 3 to 6 and

R is an n-valent organic radical derived from an n-valent alcohol by imaginary abstraction of the n-hydroxyl groups. Preferably R is selected from the group consisting of trimethylolbutane, trimethylolpropane, trimethylolethane, pentaerythritol, glycerol, ditrimethylolpropane, dipentaerythritol, sorbitol, mannitol, diglycerol, threitol, erythritol, adonitol (ribitol), arabitol (lyxitol), xylitol, dulcitol (galactitol), maltitol, tris(hydroxymethyl) isocyanurate or tris(hydroxyethyl) isocyanurate (THEIC), more preferably trimethylolpropane, pentaerythritol, glycerol, ditrimethylolpropane, and dipentaerythritol, and very preferably trimethylolpropane, pentaerythritol, and glycerol.

As one possibility for preparing the urethanes, 2,4′-MDI is introduced initially and the diol or polyol (c1), or the n-valent alcohol or the polyol mixture, dissolved if appropriate in a solvent, is added slowly. The stoichiometry in this case is preferably about n mol of 2,4′-MDI (here, exceptionally, based on n mol of 2,4′-MDI, instead of isocyanate groups) per mole of hydroxyl groups in the n-valent diol or polyol, more preferably (0.5 to 1.5*n) n, very preferably at least (0.8 to 1.2*n): n, and in particular at least (0.9 to 1.1*n) n (mol of 2,4′-MDI: mol of hydroxyl groups).

In one particularly preferred embodiment any excess of monomeric, unreacted 2,4′-MDI after urethanization is not separated off but instead used together with the comprised urethane in the following reaction.

This has the advantage that, in the case of such inventive preparation of the urethane of the 2,4′-MDI, it is possible to avoid separating off the monomeric, unreacted 2,4′-MDI. On account of its low toxicity as compared with TDI, no disadvantages are to be expected here from the presence of unreacted monomers. It is one of the surprising results of this invention that the coating composition has very good hardness and other good film properties despite the use of 2,4′-MDI in partly monomeric form.

It will be appreciated that 2,4′-MDI can also be reacted with an n-valent alcohol as described above to give a urethane with subsequent distillative removal of unreacted monomeric 2,4′-MDI from the reaction product. In this case it is also possible to use the 2,4′-MDI in a molar excess relative to the hydroxyl groups; for example, in an excess of up to ten times.

The optional structural component (b) is at least one other diisocyanate or polyisocyanate than 2,2′-, 4,4′- or 2,4-MDI.

Examples of such are aliphatic, aromatic, and cycloaliphatic di- and polyisocyanates having an NCO functionality of at least 1.8, preferably 1.8 to 5, and more preferably 2 to 4.

The diisocyanates are preferably isocyanates having 4 to 20 carbon atoms. Examples of typical diisocyanates are aliphatic diisocyanates such as tetramethylene diisocyanate, hexamethylene diisocyanate (1,6-diisocyanatohexane), octamethylene diisocyanate, decamethylene diisocyanate, dodecamethylene diisocyanate, tetradecamethylene diisocyanate, derivatives of lysine diisocyanates, tetramethylxylylene diisocyanate, trimethylhexane diisocyanate or tetramethylhexane diisocyanate, cycloaliphatic diisocyanates such as 1,4-, 1,3- or 1,2-diisocyanatocyclohexane, 4,4′- or 2,4′-di(isocyanatocyclohexyl)methane, 1-isocyanato-3,3,5-trimethyl-5-(isocyanatomethyl)cyclohexane (isophorone diisocyanate), 1,3- or 1,4-bis(isocyanatomethyl)cyclohexane or 2,4-, or 2,6-diisocyanato-1-methylcyclohexane, and aromatic diisocyanates such as tolylene 2,4- or 2,6-diisocyanate and the isomer mixtures thereof, m- or p-xylylene diisocyanate, phenylene 1,3- or 1,4-diisocyanate, 1-chlorophenylene 2,4-diisocyanate, naphthylene 1,5-diisocyanate, diphenylene 4,4′-diisocyanate, 4,4′-diisocyanato-3,3′-dimethylbiphenyl, 3-methyldiphenylmethane 4,4′-diisocyanate, tetramethylxylylene diisocyanate, 1,4-diisocyanatobenzene, diphenyl ether 4,4′-diisocyanate or 3(or 4),8(or 9)-bis(isocyanatomethyl)tricyclo[5.2. 1.0^{2,6}]decane isomer mixtures.

It is also possible for mixtures of said diisocyanates to be present.

Preference is given to hexamethylene 1,6-diisocyanate, 1,3-bis(isocyanatomethyl)cyclohexane, isophorone diisocyanate, 4,4′-di(isocyanatocyclohexyl)methane, tolylene 2,4- and 2,6-diisocyanate; particular preference to hexamethylene 1,6-diisocyanate.

Suitable polyisocyanates include polyisocyanates containing isocyanurate groups, uretdione diisocyanates, polyisocyanates containing biuret groups, polyisocyanates containing urethane or allophanate groups, polyisocyanates comprising oxadiazinetrione groups or iminooxadiazinetrione groups, uretonimine-modified polyisocyanates of linear or branched C₄-C₂₀ alkylene diisocyanates, cycloaliphatic diisocyanates having a total of 6 to 20 carbon atoms or aromatic diisocyanates having a total of 8 to 20 carbon atoms, or mixtures thereof.

The useful diisocyanates and polyisocyanates (b) preferably have an isocyanate group content (calculated as NCO, molecular weight =42) of 5% to 60% by weight, based on the di- and polyisocyanate (mixture), more preferably 10% to 60% by weight, and very preferably 15% to 55% by weight.

Preference is given to aliphatic and/or cycloaliphatic di- and polyisocyanates, examples being the aforementioned aliphatic or cycloaliphatic diisocyanates, or mixtures thereof.

Preference is further given to
1) Polyisocyanates containing isocyanurate groups and derived from aromatic, aliphatic and/or cycloaliphatic diisocyanates. Particular preference is given in this context to the corresponding aliphatic and/or cycloaliphatic isocyanato-isocyanurates and in particular to those based on hexamethylene diisocyanate and isophorone diisocyanate or based on 2,4- and/or 2,6-TDI. The isocyanurates present are, in particular, tris-isocyanatoalkyl and/or tris-isocyanatocycloalkyl isocyanurates, which constitute cyclic trimers of the diisocyanates, or are mixtures with their higher homologues containing more than one isocyanurate ring. The isocyanato-isocyanurates generally have an NCO content of 10% to 30% by weight, in particular 15% to 25% by weight, and an average NCO functionality of 3to 8.
2) Uretdione diisocyanates with aromatically, aliphatically and/or cycloaliphatically attached isocyanate groups, preferably aliphatically and/or cycloaliphatically attached, and in particular those derived from hexamethylene diisocyanate or isophorone diisocyanate. Uretdione diisocyanates are cyclic dimerization products of diisocyanates.
The uretdione diisocyanates can be used in the preparations as a sole component or in a mixture of other polyisocyanates, particularly those specified under 1).
3) Polyisocyanates containing biuret groups and having aromatically, cycloaliphatically or aliphatically attached, preferably cycloaliphatically or aliphatically attached, isocyanate groups, especially tris(6-isocyanatohexyl)biuret or its mixtures with its higher homologues. These polyisocyanates containing biuret groups generally have an NCO content of 18% to 25% by weight and an average NCO functionality of 3 to 4.5.
4) Polyisocyanates containing urethane and/or allophanate groups and having aromatically, aliphatically or cycloaliphatically attached, preferably aliphatically or cycloaliphatically attached, isocyanate groups, such as may be obtained, for example, by reacting excess amounts of hexamethylene diisocyanate or of isophorone diisocyanate with polyhydric alcohols such as trimethylolpropane, neopentyl glycol, pentaerythritol, 1,4-butanediol, 1,6-hexanediol, 1,3-propanediol, ethylene glycol, diethylene glycol, glycerol, 1,2-dihydroxypropane or mixtures thereof. These polyisocyanates containing urethane and/or allophanate groups generally have an NCO content of 12% to 20% by weight and an average NCO functionality of at least 2, preferably at least 2.1, and more preferably 2.5 to 3.
5) Polyisocyanates comprising oxadiazinetrione groups, derived preferably from hexamethylene diisocyanate or isophorone diisocyanate. Polyisocyanates of this kind comprising oxadiazinetrione groups are preparable from diisocyanate and carbon dioxide. Account should, however, be taken, if appropriate, of the above-recited amount of oxadiazinetrione groups.
6) Polyisocyanates comprising iminooxadiazinedione groups, derived preferably from hexamethylene diisocyanate or isophorone diisocyanate. Polyisocyanates of this kind comprising iminooxadiazinedione groups are preparable from diisocyanates by means of specific catalysts. Catalyst and process are described, for example, in EP 798299 A1.
7) Uretonimine-modified polyisocyanates.

Polyisocyanates 1) to 7) can be used in a mixture, including, if appropriate, in a mixture with diisocyanates.

Suitable compounds (c) include those having at least two isocyanate-reactive groups.

These may on the one hand be compounds (c1), as mentioned above, which are used for construction of a urethane prepolymer, and, on the other hand, compounds (c2), which function as binders in the coating composition.

Isocyanate-reactive groups may for example be —OH, —SH, —NH₂, and —NHR¹, R¹ being hydrogen or an alkyl group comprising 1 to 4 carbon atoms, such as methyl, ethyl, n-propyl, iso-propyl, n-butyl, iso-butyl, sec-butyl or tert-butyl.

The groups in question are preferably —OH, —NH₂, and —NHR¹, more preferably —OH and —NH₂, and very preferably hydroxyl (—OH).

Preferably, hydroxyl groups are predominantly primary hydroxyl groups, more preferably to an extent of at least 50%, very preferably at least 75%, and in particular at least 85%.

By way of example it is possible for components (c2) to have at least 2, preferably more than 2, more preferably at least 3, and very preferably 3 to 20 isocyanate-reactive groups.

By way of example components (c2) may be polyetherols, polyesterols, polyacrylate polyols or melamine-formaldehyde resins.

Polyester polyols are known for example from Ullmanns Encyklopädie der technischen Chemie, 4th edition, Volume 19, pp. 62 to 65. It is preferred to use polyester polyols obtained by reacting dihydric alcohols with dibasic carboxylic acids. In lieu of the free polycarboxylic acids it is also possible to use the corresponding polycarboxylic anhydrides or corresponding polycarboxylic esters of lower alcohols, or mixtures thereof, to prepare the polyester polyols. The polycarboxylic acids may be aliphatic, cycloaliphatic, araliphatic, aromatic or heterocyclic and may if appropriate be substituted, by halogen atoms, for example, and/or unsaturated. Examples that may be mentioned thereof include the following:

oxalic acid, maleic acid, fumaric acid, succinic acid, glutaric acid, adipic acid, sebacic acid, dodecanedioic acid, o-phthalic acid, isophthalic acid, terephthalic acid, trimellitic acid, azelaic acid, 1,4-cyclohexanedicarboxylic acid or tetrahydrophthalic acid, suberic acid, phthalic anhydride, tetrahydrophthalic anhydride, hexahydrophthalic anhydride, tetrachlorophthalic anhydride, endomethylenetetrahydrophthalic anhydride, glutaric anhydride, maleic anhydride, dimeric fatty acids, isomers thereof and hydrogenation products thereof, and esterifiable derivatives, such as anhydrides or dialkyl esters, examples being C₁-C₄ alkyl esters, preferably methyl, ethyl or n-butyl esters, of said acids. Preference is given to dicarboxylic acids of the general formula HOOC—(CH₂)_{y}—COOH, y being a number from 1 to 20, preferably an even number from 2 to 20, and particular preference to succinic acid, adipic acid, sebacic acid, and dodecanedicarboxylic acid.

Suitable polyhydric alcohols for preparing the polyesterols include 1,2-propanediol, ethylene glycol, 2,2-dimethyl-1,2-ethanediol, 1,3-propanediol, 1,2-butanediol, 1,3-butanediol, 1,4-butanediol, 3-methylpentane-1,5-diol, 2-ethylhexane-1,3-diol, 2,4-diethyloctane-1,3-diol, 1,6-hexanediol, poly-THF having a molar mass of between 162 and 2000, poly-1,2-propanediol or poly-1,3-propanediol having a molar mass of between 134 and 10 000, preferably 134 to 5000, and more preferably 134 to 2000, or polyethylene glycol, and also mixed polyethylene/propylene glycols in the form of copolymers, it being possible for the 1,2-ethylene and 1,2-propylene units to be incorporated randomly or blockwise into the copolymer, having a molar mass of between 106 and 10 000, preferably 134 to 5000, and more preferably 134 to 2000, neopentyl glycol, neopentyl glycol hydroxypivalate, 2-ethyl-1,3-propanediol, 2-methyl-1,3-propanediol, 2,2-bis(4-hydroxycyclohexyl)propane, 1,1-, 1,2-, 1,3-, and 1,4-cyclohexanedimethanol, 1,2-, 1,3- or 1,4-cyclohexanediol, trimethylolbutane, trimethylolpropane, trimethylolethane, neopentyl glycol, pentaerythritol, glycerol, ditrimethylolpropane, dipentaerythritol, sorbitol, mannitol, diglycerol, threitol, erythritol, adonitol (ribitol), arabitol (lyxitol), xylitol, dulcitol (galactitol), maltitol, isomalt, tris(hydroxymethyl) isocyanurate or tris(hydroxyethyl) isocyanurate (THEIC). It will be appreciated that mixtures of the alcohols specifed are also suitable.

Preference is given to alcohols of the general formula HO—(CH₂)ₓ—OH, x being a number from 1 to 20, preferably an even number from 2 to 20. Preference is given to ethylene glycol, butane-1,4-diol, hexane-1,6-diol, octane-1,8-diol, and dodecane-1,12-diol. Preference is further given to neopentyl glycol.

Further, suitability is also possessed by polycarbonate diols, such as may be obtained by reacting phosgene with an excess of the low molecular mass alcohols specified as structural components for the polyester polyols.

Also suitable are lactone-based polyester diols, which are homopolymers or copolymers of lactones, preferably hydroxyl-terminated adducts of lactones with suitable difunctional starter molecules. Suitable lactones include preferably those derived from compounds of the general formula HO—(CH₂)_{z}—COOH, z being a number from 1 to 20 and it also being possible for one H atom of a methylene unit to have been substituted by a C₁ to C₄ alkyl radical. Examples are ε-caprolactone, β-propiolactone, gamma-butyrolactone and/or methyl-ε-caprolactone, 4-hydroxybenzoic acid, 6-hydroxy-2-naphthoic acid or pivalolactone, and mixtures thereof. Suitable starter components are, for example, the low molecular mass dihydric alcohols specified above as a structural component for the polyester polyols. The corresponding polymers of ε-caprolactone are particularly preferred. Lower polyester diols or polyether diols as well can be used as starters for preparing the lactone polymers. In lieu of the polymers of lactones it is also possible to use the corresponding, chemically equivalent polycondensates of the hydroxy carboxylic acids corresponding to the lactones.

The polyesters preferably have a molecular weight Mₙ (number average), as determinable by gel permeation chromatography, of 500 to 50 000, in particular 1000 to 10 000 g/mol and a hydroxyl number of 16.5 to 264, preferably 33 to 165 mg KOH/g resin solids.

Furthermore, polyacrylate polyols are preferred. These are copolymers of substantially (meth)acrylic esters, examples being the C₁-C₂₀ alkyl (meth)acrylates recited above in connection with the reactive diluents, with hydroxyalkyl (meth)acrylates, examples being the mono(meth)acrylic esters of 1,2-propanediol, ethylene glycol, 1,3-propanediol, 1,4-butanediol or 1,6-hexanediol.

These preferably have a molecular weight Mₙ (number average) as determinable by gel permeation chromatography of 500 to 50 000, in particular 1000 to 10 000 g/mol and a hydroxyl number of 16.5 to 264, preferably 33 to 165 mg KOH/g resin solids.

The monomers which have hydroxyl groups are used in the copolymerization in amounts such as to result in the abovementioned hydroxyl numbers of the polymers, which correspond, moreover, in general to a hydroxyl group content for the polymers of 0.5% to 8%, preferably 1% to 5% by weight. In general the hydroxy-functional comonomers are used in amounts of 3% to 75%, preferably 6% to 47% by weight, based on the total weight of the monomers employed. Furthermore, as will be appreciated, it is necessary to ensure that in the context of the figures given the amount of hydroxy-functional monomers is selected so as to produce copolymers which have on average per molecule at least two hydroxyl groups.

The non-hydroxy-functional monomers include, for example, reactive diluents—that is, free-radically or cationically polymerizable compounds having only one ethylenically unsaturated, copolymerizable group.

Mention may be made, by way of example, of C₁-C₂₀ alkyl (meth)acrylates, vinylaromatics having up to 20 carbon atoms, vinyl esters of carboxylic acids comprising up to 20 carbon atoms, ethylenically unsaturated nitrites, vinyl ethers of alcohols comprising 1 to 10 carbon atoms, α,β-unsaturated carboxylic acids and their anhydrides, and aliphatic hydrocarbons having 2 to 8 carbon atoms and 1 or 2 double bonds.

Preferred (meth)acrylic acid alkyl esters are those having a C₁-C₁₀ alkyl radical, such as methyl methacrylate, methyl acrylate, n-butyl acrylate, ethyl acrylate, and 2-ethylhexyl acrylate.

In particular, mixtures of the (meth)acrylic acid alkyl esters are also suitable.

Examples of vinyl esters of carboxylic acids having 1 to 20 carbon atoms are vinyl laurate, vinyl stearate, vinyl propionate, and vinyl acetate.

Possible examples of α,β-unsaturated carboxylic acids and their anhydrides include acrylic acid, methacrylic acid, fumaric acid, crotonic acid, itaconic acid, maleic acid or maleic anhydride, preferably acrylic acid.

Examples of suitable vinylaromatic compounds include vinyltoluene, α-butylstyrene, 4-n-butylstyrene, 4-n-decylstyrene, and, preferably, styrene.

Examples of nitriles are acrylonitrile and methacrylonitrile.

Examples of suitable vinyl ethers are vinyl methyl ether, vinyl isobutyl ether, vinyl hexyl ether, and vinyl octyl ether.

As nonaromatic hydrocarbons having 2 to 8 carbon atoms and one or two olefinic double bonds mention may be made of butadiene, isoprene, and also ethylene, propylene, and isobutylene.

In addition it is possible to use N-vinylformamide, N-vinylpyrrolidone, and N-vinylcaprolactam.

Preference is given to esters of acrylic acid or of methacrylic acid having 1 to 18, preferably 1 to 8, carbon atoms in the alcohol residue, such as methyl acrylate, ethyl acrylate, isopropyl acrylate, n-propyl acrylate, n-butyl acrylate, 2-ethylhexyl acrylate, n-stearyl acrylate, the methacrylates corresponding to these acrylates, styrene, alkyl-substituted styrenes, acrylonitrile, methacrylonitrile, vinyl acetate or vinyl stearate, or any desired mixtures of such monomers. Comonomers containing epoxide groups, as well, such as glycidyl acrylate or methacrylate, or monomers such as N-methoxymethylacrylamide or N-methoxymethylmethacrylamide, can be used in small amounts.

The polymers can be prepared by polymerization in accordance with customary methods. Preferably the polymers are prepared in organic solution. Continuous or discontinuous polymerization methods are possible. Of the discontinuous methods, mention may be made of the batch method and the feed method, the latter being preferred. With the feed method the solvent is introduced as an initial charge, on its own or together with a fraction of the monomer mixture, this initial charge is heated to the polymerization temperature, the polymerization is initiated free-radically in the case of an initial monomer charge, and the remaining monomer mixture is metered in together with an initiator mixture in the course of 1 to 10 hours, preferably 3 to 6 hours. If appropriate, activation is performed again subsequently in order to take the polymerization to a conversion of at least 99%.

Suitable solvents include, for example, aromatics, such as solvent naphtha, benzene, toluene, xylene, chlorobenzene, esters such as ethyl acetate, butyl acetate, methyl glycol acetate, ethyl glycol acetate, methoxypropyl acetate, ethers such as butyl glycol, tetrahydrofuran, dioxane, ethyl glycol ether, ketones such as acetone, methyl ethyl ketone, and halogenated solvents such as methylene chloride or trichloromonofluoroethane.

Preferred polyetherols are alkoxylated diols or polyols, more preferably the above-recited diols or polyols (c1) in alkoxylated form.

Epoxidized olefins suitable for the alkoxylation may, for example, be ethylene oxide, propylene oxide, isobutylene oxide, 1-butene oxide, 2-butene oxide, vinyloxirane, styrene oxide and/or epichlorohydrin; preference is given to ethylene oxide, propylene oxide, isobutylene oxide, vinyloxirane,.styrene oxide or epichlorohydrin, particular preference to ethylene oxide and propylene oxide, and very particular preference to ethylene oxide.

Copolymers may be random or block copolymers.

It constitutes a preferred embodiment of the present invention to form a coating composition at least in part from monomeric, pure 2,4′-MDI as component (a) with binders (c2).

It constitutes a further, particularly preferred embodiment of the present invention to form a coating composition from 2,4′-MDI as component (a), reacted beforehand with at least one compound (c1) to give a urethane and then mixed subsequently with at least one binder (c2).

A further process for preparing coating compositions comprising 2,4′-diisocyanatodiphenylmethane is provided by the present invention, and involves initially introducing a mixture of 2,4′-diisocyanatodiphenyl methane (MDI) and 4,4′-diisocyanatodiphenylmethane (MDI), and, if appropriate, 2,2′-diisocyanatodiphenylmethane in at least one solvent, and adding thereto at least one n-valent diol or polyol (c1), it being possible for n to adopt values from 2 to 6, and adding, simultaneously or subsequently, at least one binder (c2). It is also possible here to add the compound (c1) decreasingly and to meter the compound (c2) increasingly, so that the addition of hydroxyl-containing compounds takes place at the beginning with pure compound (c1) and at the end with pure compound (c2). In the interim it is possible for the fraction of (c1) to be reduced steadily or in steps and for the fraction of (c2) to be increased correspondingly.

Preferred coating compositions of the invention are two-component (2K) coating compositions. This means that the isocyanate group-containing components and the components having isocyanate-reactive groups, especially the components (a) and (c2), are not mixed with one another until shortly before application to the substrate (see below) and then react with one another substantially only after application to the substrate.

In contrast thereto are one-component heated compositions, as described for example in WO 03/33562, which have been mixed with one another a long time before application.

The optional compounds (d) are compounds having one isocyanate-reactive group.

They are preferably monools, more preferably alkanols, and very preferably alkanols having 1 to 20, more preferably 1 to 12, very preferably 1 to 6, with very particular preference 1 to 4, and in particular 1 to 2 carbon atoms.

Examples thereof are methanol, ethanol, isopropanol, n-propanol, n-butanol, isobutanol, sec-butanol, tert-butanol, n-hexanol, n-heptanol, n-octanol, n-decanol, n-dodecanol (lauryl alcohol), 2-ethylhexanol, cyclopentanol, cyclohexanol, cyclooctanol, cyclododecanol, ethylene glycol monomethyl ether, ethylene glycol monoethyl ether, diethylene glycol, 1,3-propanediol monomethyl ether, preference being given to methanol, ethanol, isopropanol, n-propanol, n-butanol, tert-butanol, n-hexanol, 2-ethylhexanol, cyclopentanol, cyclohexanol, and cyclododecanol, particular preference to methanol, ethanol, isopropanol, n-propanol, n-butanol, and tert-butanol, very particular preference to methanol and ethanol, and in particular methanol.

In one preferred embodiment the monools may be the stated cycloaliphatic alcohols, preferably cyclopentanol or cyclohexanol, more preferably cyclohexanol.

In another preferred embodiment the monools may be the stated aliphatic alcohols having 6 to 20 carbon atoms, more preferably those having 8 to 20 carbon atoms, very preferably those having 10 to 20 carbon atoms.

In one particularly preferred embodiment the monools are the stated aliphatic alcohols, with very particular preference those having 1 to 4 carbon atoms, especially methanol.

In a further alternative embodiment the monools are at least one monofunctional polyalkylene oxide polyether alcohol obtainable by alkoxylating suitable starter molecules.

Suitable starter molecules for preparing monohydric polyalkylene oxide polyether alcohols are thiol compounds, monohydroxy compounds of the general formula

R⁵—O—H

or secondary monoamines of the general formula

R⁶R⁷N—H,

in which

R⁵, R⁶, and R⁷ independently of one another are in each case C₁-C₁₈ alkyl, uninterrupted C₂-C₁₈ alkyl or C₂-C₁₈ alkyl interrupted by one or more oxygen and/or sulfur atoms and/or by one or more substituted or unsubstituted imino groups, or are C₆-C₁₂ aryl, C₅-C₁₂ cycloalkyl or a five- to six-membered, oxygen-, nitrogen- and/or sulfur-containing heterocycle, or R⁶ and R⁷ together form a ring which is unsaturated, saturated or aromatic and is uninterrupted or interrupted by one or more oxygen and/or sulfur atoms and/or by one or more substituted or unsubstituted imino groups, it being possible for the stated radicals to be substituted in each case by functional groups, aryl, alkyl, aryloxy, alkyloxy, halogen, heteroatoms and/or heterocycles.

Preferably R⁵, R⁶, and R⁷ independently of one another are C₁ to C₄ alkyl, i.e., methyl, ethyl, isopropyl, n-propyl, n-butyl, isobutyl, sec-butyl or tert-butyl; more preferably R⁵, R⁶, and R⁷ are methyl.

Monofunctional starter molecules suitable by way of example may be saturated monoalcohols such as methanol, ethanol, n-propanol, isopropanol, n-butanol, isobutanol, sec-butanol, the isomeric pentanols, hexanols, octanols, and nonanols, n-decanol, n-dodecanol, n-tetradecanol, n-hexadecanol, n-octadecanol, cyclohexanol, cyclopentanol, the isomeric methylcyclohexanols or hydroxymethylcyclohexane, 3-ethyl-3-hydroxymethyloxetane, or tetrahydrofurfuryl alcohol; unsaturated alcohols such as allyl alcohol, 1,1-dimethylallyl alcohol or oleyl alcohol, aromatic alcohols such as phenol, the isomeric cresols or methoxyphenols, araliphatic alcohols such as benzyl alcohol, anisyl alcohol or cinnamyl alcohol; secondary monoamines such as dimethylamine, diethylamine, dipropylamine, diisopropylamine, di-n-butylamine, diisobutylamine, bis-(2-ethylhexyl)amine, N-methyl- and N-ethylcyclohexylamine or dicyclohexylamine, heterocyclic secondary amines such as morpholine, pyrrolidine, piperidine and 1H-pyrazole, and also amino alcohols such as 2-dimethylaminoethanol, 2-diethylaminoethanol, 2-diisopropylaminoethanol, 2-dibutylaminoethanol, 3-(dimethylamino)-1-propanol or 1-(dimethylamino)-2-propanol.

Alkylene oxides suitable for the alkoxylation reaction are ethylene oxide, propylene oxide, isobutylene oxide, vinyloxirane and/or styrene oxide, which can be used in any order or else in a mixture for the alkoxylation reaction.

Preferred alkylene oxides are ethylene oxide, propylene oxide, and mixtures thereof; ethylene oxide is particularly preferred.

Preferred polyether alcohols are those based on polyalkylene oxide polyether alcohols prepared using saturated aliphatic or cycloaliphatic alcohols of the aforementioned kind as starter molecules. Very particular preference is given to those based on polyalkylene kylene oxide polyether alcohols prepared using saturated aliphatic alcohols having 1 to 4 carbon atoms in the alkyl radical. Especial preference is given to polyalkylene oxide polyether alcohols prepared starting from methanol.

The monohydric polyalkylene oxide polyether alcohols have on average in general at least two alkylene oxide units, preferably 5 ethylene oxide units, per molecule, more preferably at least 7, with very particular preference at least 10, and in particular at least 15.

The monohydric polyalkylene oxide polyether alcohols have on average in general up to 50 alkylene oxide units, preferably ethylene oxide units, per molecule, preferably up to 45, more preferably up to 40, and very preferably up to 30.

The molar weight of the monohydric polyalkylene oxide polyether alcohols is preferably up to 4000, more preferably not more than 2000 g/mol, with very particular preference not below 500 and in particular 1000±200 g/mol.

Preferred polyether alcohols are, therefore, compounds of the formula

R⁵—O—[—Xᵢ—]ₖ—H

in which

R⁵ is as defined above,

k is an integer from 5 to 40, preferably 7 to 45, and more preferably 10 to 40, and each Xᵢ, independently of one another for i=1 to k, may be selected from the group —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh—O—, and —CHPh—CH₂—O—, preferably from the group —CH₂—CH₂—O—, —CH₂—CH(CH₃)—O—, and —CH(CH₃)—CH₂—O—, and more preferably —CH₂—CH₂—O—

in which Ph is phenyl and Vin is vinyl.

In a further alternative embodiment the monools are at least one compound having an isocyanate-reactive group and at least one dispersive group.

Such compounds are represented for example by the general formula

RG-R³-DG

in which

RG is at least one isocyanate-reactive group,

DG is at least one dispersive group, and

R³ is an aliphatic, cycloaliphatic or aromatic radical comprising 1 to 20 carbon atoms.

Examples of RG are —OH, —SH, —NH₂ or —NHR₄, in which R₄ has the definition indicated above for R⁵, but may be different from the radical used there.

Examples of DG are —COOH, —SO₃H or —PO₃H and also their anionic forms, with which any desired counterion may be associated, (e.g., Li⁺, Na⁺, K⁺, Cs⁺, Mg²⁺, Ca²⁺, Ba²⁺, ammonium, methylammonium, dimethylammonium, trimethylammonium, ethylammonium, diethylammonium, triethylammonium, tributylammonium, diisopropylethylammonium, benzyldimethylammonium, monoethanolammonium, diethanolammonium, triethanolammonium, hydroxyethyldimethylammonium, hydroxyethyldiethylammonium, monopropanolammonium, dipropanolammonium, tripropanolammonium, piperidinium, piperazinium, N,N′-dimethylpiperazinium, morpholinium or pyridinium.

R³ can for example be methylene, 1,2-ethylene, 1,2-propylene, 1,3-propylene, 1,2-butylene, 1,4-butylene, 1,3-butylene, 1,6-hexylene, 1,8-octylene, 1,12-dodecylene, 1,2-phenylene, 1,3-phenylene, 1,4-phenylene, 1,2-naphthylene, 1,3-naphthylene, 1,4-naphthylene, 1,6-naphthylene, 1,2-cyclopentylene, 1,3-cyclopentylene, 1,2-cyclohexyiene, 1,3-cyclohexylene or 1,4-cyclohexylene.

The compound in question is preferably mercaptoacetic acid, mercaptopropionic acid, thiolactic acid, mercaptosuccinic acid, glycine, iminodiacetic acid, sarcocine, alanine, β-alanine, leucine, isoleucine, aminobutyric acid, hydroxyacetic acid, hydroxypivalic acid, lactic acid, hydroxysuccinic acid, hydroxydecanoic acid, dimethylolpropionic acid, dimethylolbutyric acid, ethylenediaminetriacetic acid, hydroxydodecanoic acid, hydroxyhexadecanoic acid, 12-hydroxystearic acid, aminonaphthalenecarboxylic acid, hydroxyethanesulfonic acid, hydroxypropanesulfonic acid, mercaptoethanesulfonic acid, mercaptopropanesulfonic acid, aminomethanesulfonic acid, taurine, aminopropanesulfonic acid, 2-cyclohexylaminopropanesulfonic acid, 2-cyclohexylaminoethanesulfonic acid, and the alkali metal, alkaline earth metal or ammonium salts thereof, and, with particular preference, the stated monohydroxycarboxylic and -sulfonic acids and also monoaminocarboxylic and -sulfonic acids.

To prepare the dispersion the aforementioned acids, if not already in salt form, are fully or partly neutralized, preferably with alkali metal salts or amines, preferably tertiary amines.

In a further alternative embodiment at least part of the compounds (d) constitute at least one compound having an isocyanate-reactive group and at least one free-radically polymerizable unsaturated group.

Examples thereof are 2-hydroxyethyl (meth)acrylate, 2- or 3-hydroxypropyl (meth)acrylate, 1,4-butanediol mono(meth)acrylate, neopentyl glycol mono(meth)acrylate, 1,5-pentanediol mono(meth)acrylate, 1,6-hexanediol mono(meth)acrylate, glycerol di(meth)acrylate, trimethylolpropane monodi(meth)acrylate, pentaerythritol tri(meth)acrylate, and 4-hydroxybutyl vinyl ether, 2-aminoethyl (meth)acrylate, 2-aminopropyl (meth)acrylate, 3-aminopropyl (meth)acrylate, 4-aminobutyl (meth)acrylate, 6-aminohexyl (meth)acrylate, 2-thioethyl (meth)acrylate, 2-aminoethyl(meth)acrylamide, 2-aminopropyl(meth)acrylamide, 3-aminopropyl(meth)acrylamide, 2-hydroxyethyl(meth)acrylamide, 2-hydroxypropyl(meth)acrylamide or 3-hydroxypropyl(meth)acrylamide. Preference is given to 2-hydroxyethyl acrylate, 2-hydroxyethyl methacrylate, 2- or 3-hydroxypropyl acrylate, 1,4-butanediol monoacrylate, 3-(acryloyloxy)-2-hydroxypropyl (meth)acrylate, and the monoacrylates of polyethylene glycol with a molar mass of 106 to 238.

The reaction products are obtained by reacting the structural components (a), (b), (c) and (d) in a stoichiometry as follows:

(b) 0 to 500 mol % NCO groups, preferably 0 to 250 mol %, more preferably 1 to 200, very preferably 10 to 150, and in particular 50 to 100 mol % NCO groups (based on 100 mol % NCO groups in (a)),

(c) 50 to 100 mol % of isocyanate-reactive groups, preferably 70 to 100, more preferably 70 to 95, and very preferably 75 to 95 mol % of isocyanate-reactive groups (based on 100 mol % of NCO groups in (a) and also, if appropriate, (b), where present),

(d) 0 to 50 mol % of isocyanate-reactive groups, preferably 0 to 30, more preferably 5 to 30, and very preferably 5 to 25 mol % of isocyanate-reactive groups (based on 100 mol % of NCO groups in (a) and also, if appropriate, (b), where present).

In general the isocyanate group-containing components and the components having isocyanate-reactive groups are mixed substantially equimolarly with one another; in other words, the excess or deficit of the components containing isocyanate groups with respect to the components containing isocyanate-reactive groups is not more than 5 mol %, preferably not more than 4 mol %, with particular preference not more than 3, with very particular preference not more than 2, and in particular not more than 1 mol %.

In particular it is essential to the invention that the ratio of isocyanate groups in (a) to isocyanate-reactive groups from (c) and (d) amounts to less than 1.05:1, preferably not more than 1:1, more preferably not more than 0.99:1, with very particular preference not more than 0.98:1, in particular not more than 0.95:1, and especially not more than 0.9:1.

If at least one compound (b) is present, the ratio of isocyanate groups in (a) and (b) (in toto) to isocyanate-reactive groups from (c) and (d) (in toto) amounts to not more than 1.3:1, preferably not more than 1.2:1, more preferably not more than 1.1:1, and very preferably not more than 1.05:1.

In general the ratio of isocyanate groups in (a) and, if present, (b) (in toto) to isocyanate-reactive groups from (c) and (d) it amounts to at least 0.7:1, preferably at least 0.8:1, and more preferably at least 0.85:1.

The coating materials of the invention also comprise, furthermore, at least one solvent (e), examples of which are aromatic and/or (cyclo)aliphatic hydrocarbons and mixtures thereof, halogenated hydrocarbons, ketones, esters, and ethers, or mixtures thereof. As a result they are not preferred for use in adhesive compositions.

Preference is given to those having a boiling point below 180° C., more preferably below 150, very preferably below 120, and in particular below 100° C.

Examples of ketones are acetone, 2-butanone, 2-pentanone, 3-pentanone, hexanone, isobutyl methyl ketone, heptanone, cyclopentanone, cyclohexanone or cycloheptanone.

Examples of ethers are dioxane or tetrahydrofuran; examples of esters are alkoxyalkyl carboxylates such as triethylene glycol diacetate, butyl acetate, ethyl acetate, 1-methoxy-2-propyl acetate, propylene glycol diacetate; further, 2-butanone or 4-methyl-2-pentanone may also be used.

Particular preference is given to mono- or polyalkylated benzenes and naphthalenes and also to mixtures thereof.

Preferred aromatic hydrocarbon mixtures are those comprising predominantly aromatic C₇ to C₁₄ hydrocarbons and possibly comprising a boiling range of 110 to 300° C.; particular preference is given to toluene, o-, m- or p-xylene, trimethylbenzeneisomers, tetramethylbenzeneisomers, ethylbenzene, cumene, tetrahydronaphthalene, and mixtures comprising such.

Examples thereof are the Solvesso® grades from ExxonMobil Chemical, especially Solvesso® 100 (CAS No. 64742-95-6, predominantly C₉ and C₁₀ aromatics, boiling range about 154-178° C.), 150 (boiling range about 182-207° C.), and 200 (CAS No. 64742-94-5), and also the Shellsol® grades from Shell. Hydrocarbon mixtures comprising paraffins, cycloparaffins, and aromatics are also available commercially under the names Kristalloel (for example, Kristalloel 30, boiling range about 158-198° C., or Kristalloel 60: CAS No. 64742-82-1), white spirit (likewise, for example, CAS No. 64742-82-1) or solvent naphtha (light: boiling range about 155-180° C., heavy: boiling range about 225-300° C.). The aromatics content of such hydrocarbon mixtures is generally more than 90% by weight, preferably more than 95%, more preferably more than 98%, and very preferably more than 99% by weight. It may be sensible to use hydrocarbon mixtures having a particularly reduced naphthalene content.

Also conceivable are trimethyl phosphate, tri-n-butyl phosphate, and triethyl phosphate, or any desired mixtures of these compounds.

Where the coating compositions of the invention, by virtue of hydrophilic side chains, are emulsifiable in water, then water is also conceivable as a solvent.

Solvents are commonly not comprised at more than 70% by weight in the coating compositions of the invention, preferably at not more than 66%, more preferably at not more than 50%, very preferably at not more than 40%, in particular at not more than 30%, and especially at not more than 20% by weight.

With the aid of the solvent the viscosity of the coating composition is adapted to the requirements of the desired application technology, so that application is possible at a temperature below 130° C., preferably below 100, more preferably below 80, very preferably below 60, and in particular at room temperature.

The viscosity of the coating compositions of the invention is adjusted, by addition of the solvent, to a viscosity in accordance with DIN ISO 3219 of 20 to 10 000 mpas, preferably of 25 mPas to 5000 mPas, more preferably 30 mPas to 2000 mPas, and very preferably 30 to 1000 mPas, at a temperature of 23° C.

It is additionally possible for further, typical coatings additives to be comprised in the coating compositions of the invention, examples being antioxidants, stabilizers, activators (accelerants), fillers, pigments, dyes, antistats, flame retardants, thickeners, thixotropic agents, surface-active agents, viscosity modifiers, plasticizers or chelating agents.

Suitable thickeners include, in addition to free-radically (co)polymerized (co)polymers, typical organic and inorganic thickeners such as hydroxymethylcellulose or bentonite.

As chelating agents it is possible, for example, to use ethylenediamineacetic acid and its salts and also β-diketones.

Suitable fillers comprise silicates, examples being silicates obtainable by hydrolysis of silicon tetrachloride, such as Aerosil® from Degussa, salicious earth, talc, aluminum silicates, magnesium silicates, calcium carbonates, etc.

Suitable stabilizers comprise typical UV absorbers such as oxanilides, triazines, and benzotriazole (the latter obtainable as Tinuvin® grades from Ciba-Spezialitätenchemie), and benzophenones. They can be used alone or together with suitable free-radical scavengers, examples being sterically hindered amines such as 2,2,6,6-tetramethylpiperidine, 2,6-di-tert-butylpiperidine or derivatives thereof, e.g., bis(2,2,6,6-tetramethyl-4-piperidyl) sebacate. Stabilizers are used typically in amounts of from 0.1% to 5.0% by weight, based on the solid components comprised in the preparation.

The coating compositions of the invention can be used for coating a variety of substrates, such as wood, wood veneer, paper, board, card, textile, leather, nonwoven, plastics surfaces, glass, ceramic, mineral building materials, metals, including coating metals; preferably wood, plastics surfaces, and metals including coated metals; more preferably wood and coated metals; and very preferably wood.

In one preferred embodiment the coating compositions are used in transparent coating materials for coating paper surfaces or wood surfaces exposed only to low-intensity illumination, preferably for coating wood block flooring, furniture, interior fitments or laminate.

The coating of the substrates with the coating compositions of the invention takes place in accordance with typical methods known to the skilled worker, where a coating composition of the invention or a coating formulation comprising such is applied to the target substrate in the desired thickness and, if appropriate, is dried. This operation can be repeated one or more times if desired. Application to the substrate may take place in a known way, by means, for example, of spraying, troweling, knifecoating, brushing, rolling, rollercoating, pouring, laminating, injection backmolding or coextruding. The coating thickness is generally in a range from about 3 to 1000 g/m² and preferably 10 to 200 g/m².

A further preferred subject of the present invention is a method of coating substrates, which comprises mixing the isocyanate group-containing components and the components having isocyanate-reactive groups, and also, if appropriate, other, typical coatings additives with one another, and applying the mixture within a period of not more than 12 hours, preferably not more than 10, more preferably not more than 9 hours after mixing to the substrate, and subsequently carrying out drying and curing.

Drying here is the time period in which dust no longer adheres to the surface of the coating material applied to the substrate (i.e., coating). For the system of the invention the drying time is typically up to 8 hours or up to 4 hours, preferably up to 120 minutes, more preferably up to 90 min, with very particular preference up to 60 min, in particular up to 45 min, especially up to 30 min, and even up to 20 min.

Curing follows and leads to a substantially complete reaction of the isocyanate groups, to an isocyanate group conversion of more than 80%, preferably more than 85%, more preferably more than 90%, very preferably more than 95%, and in particular more than 97%.

Curing takes place in general at a temperature of at least 60° C., preferably at least 70° C., more preferably at least 80° C., and very preferably at least 90° C., over a time of at least 5 minutes, preferably at least 10 minutes, more preferably at least 20 minutes, and very preferably at least 30 minutes.

In general, depending on the choice of temperature, 48 hours are sufficient for curing, preferably up to 12 h, more preferably up to 6 h, very preferably up to 2 h, and in particular up to 1 h.

In exceptional cases curing may also take place at lower temperatures: for example, ambient temperatures or a little above, and in considerably longer time periods of two or more days.

Drying and/or curing may also take place, in addition to or instead of the thermal treatment, by means of NIR radiation, NIR radiation here being electromagnetic radiation in the wavelength range from 760 nm to 2.5 μm, preferably from 900 to 1500 nm.

With the aid of the coating compositions of the invention it is possible to substitute prepolymers based on tolylene 2,4- and 2,6-diisocyanate (TDI) or isomer mixtures of 2,4′- and 4,4′-diisocyanatodiphenylmethane (MDI) in coating compositions.

In general there exists the advantage over the stated systems that it is possible to dispense with the costly and inconvenient prepolymer preparation entailing a distillation of monomer.

As compared with TDI, the advantage of the coating compositions of the invention is that 2,4′-MDI has a lower toxicity and endows the coating compositions with a greater flexibility.

As compared with isomer mixtures of 2,4′- and 4,4′-diisocyanatodiphenylmethane (MDI) and 4,4′-MDI alone, 2,4′-MDI has the advantage that it has a lower reactivity and hence a greater selectivity, resulting in a longer potlife and producing a reduced geling tendency. Moreover, coating materials formulated with pure 2,4′-MDI score better for hardness than those formulated, correspondingly, with an isomer mixture, and score much better for hardness than those formulated with the pure 4,4′-MDI isomer.

It is a further advantage of the coating compositions of the invention that after application they dry rapidly and become tack-free. The latter point distinguishes the coating compositions of the invention from the adhesive compositions described in WO 03/033562.

Unless otherwise indicated, ppm and percentage figures used in this text refer to ppm and percentages by weight.

The examples which follow are intended to illustrate the invention but not to confine it to these examples.

### EXAMPLES

### Examples 1-4

In the example below a coating composition of the invention, comprising pure 2,4′-MDI with a fraction of the 2,4′ isomer of at least 97.5%, was compared with conventional, prior art coating compositions comprising pure 4,4′-MDI, and an approximately 1:1 mixture of 2,4′-MDI and 4,4′-MDI, and a higher-functionality polyisocyanate (TDI prepolymer) based on 2,4-/2,6-TDI (Basonat® TU 75E from BASF AG). The binder used in each case was the hydroxyl-containing acrylic resin Macrynal® SM636 (polyacrylate polyol having an OH number of 125-150 and a viscosity amounting to 7000-13 000 mPas) from Cytec (formerly UCB) as a 70% strength solution in butyl acetate. The precise constitution of the coating compositions is indicated in Table 1.

TABLE 1

| | 1 | 2 | 3 | 4 |
|---|---|---|---|---|
| Macrynal ® SM636, | 11.4 g | 11.4 g | 11.4 g | 11.4 g |
| 70% in butyl acetate | | | | |
| Pure 2,4′-MDI | 2.5 g | | | |
| TDI prepolymer | | 6.3 g | | |
| Pure 4,4′-MDI | | | 2.5 g | |
| 2,4′-/4,4′-MDI | | | | 2.5 g |
| Butyl acetate | 7.9 g | 8.7 g | 7.9 g | 7.9 g |

The components were mixed in a Lupolen beaker using a wooden spatula and the mixture was cast to a film with a wet thickness of 200 μm. The samples were left at room temperature for four hours for evaporation and then cured on a Bonder metal panel at 60° C. for 15 hours.

Two coatings in each case were tested for their flexibility, by measurement of the Erichsen cupping in millimeters, and for their pendulum hardness, in strokes.

| | 1 | 2 | 3 | 4 |
|---|---|---|---|---|
| Erichsen cupping [mm] | 7.0/7.1 | 6.7/6.6 | 7.5/7.3 | 7.5/7.6 |
| Pendulum hardness | 141/142 | 136/137 | 86/87 | 137/138 |
| [strokes] | | | | |

The Erichsen cupping was determined by a method based on DIN 53156. Subsequently the Erichsen cupping was determined by impression of a metal ball. High values denote high flexibility.

The pendulum hardness was determined in accordance with DIN 53157; high values denote high hardness.

From the results it is apparent that the inventive coating composition 1 shows the greatest film hardness of the systems tested. Compared with a coating based on TDI it exhibits an increased flexibility.

### Examples 5-7

In a further experiment, in a wood-coating composition, pure 2,4′-MDI was compared with common crosslinker prepolymers. The further ingredients used were as follows: Macrynal®) SM656 (polyacrylate polyol having an OH number of 125-150 and a viscosity amounting to 7000-13 000 mpas) from Cytec (formerly UCB), nitrocellulose NC Chips E560 with 18% diethylhexyl phthalate, from Wolff Cellulosics, as co-binder, the plasticizer Acronal® 700L (ethyl acetate solution of a copolymer of butyl acrylate and vinyl isobutyl ether) from BASF, the wax dispersion Luba-Print 715/A from Bader&Co GmbH, as antisettling and thixotroping agent, the flatting agent Acematt® OK412 (surface-treated silica having a secondary particle size of 1-7 μm) from Degussa.

| | 5 | 6 | 7 |
|---|---|---|---|
| Macrynal ® SM656 | 30.0 | 30.0 | 30.0 |
| NC Chips E560 + 18% DOP | 9.0 | 9.0 | 9.0 |
| n-Butyl acetate | 29.5 | 29.5 | 29.5 |
| Methyl ethyl ketone | 11.0 | 11.0 | 11.0 |
| 1-Methoxyprop-2-yl acetate | 9.0 | 9.0 | 9.0 |
| Acronal ® 700L | 0.5 | 0.5 | 0.5 |
| Luba-Print 715/A | 10.0 | 10.0 | 10.0 |
| Acematt ® OK412 | 1.0 | 1.0 | 1.0 |
| Basonat ® HB 175 MP/X | 5.6 | | |
| Desmodur ® HL | 8.9 | | |
| Basonat ® TU 75 E | | 14.3 | |
| 2,4′-MDI, 75% in ethyl | | | 7.7 |
| acetate | | | |
| Reactivity: | | | |
| Dry to dust (min.) | 10 | 8 | 9 |
| Dry to sand (min.) | 9/6 | 6/12 | 9/18 |
| Dry through volume (min.) | 15/12 | 21/21 | 18/27 |
| Pendulum hardness | 105/105/105 | 107/109/110 | 105/106/108 |
| (15 h 60° C.) | | | |

Basonat ® HB175 MP/X: (polyisocyanate (biuret) based on hexamethylene diisocyanate, as a 75% strength solution in a 1:1 mixture of 1-methoxyprop-2-yl acetate and xylene, having an NCO content of 16%-17%),
Desmodur ® HL BA: (aromatic-aliphatic polyisocyanate based on tolylene diisocyanate/hexamethylene diisocyanate, as a 60% strength solution in butyl acetate, having an NCO content of 10%-11%),
Basonat ® TU75E (polyfunctional tolylenediisocyanate adduct, as a 75% strength solution in ethyl acetate, having an NCO content of 12.9%-13.7%).

The dry to dust time is the time period following drawdown of the coating after which, when a cotton pad is drawn over the coating, cotton filaments no longer adhere to it.

The dry to sand time is the time after drawdown of the coating at which sand no longer remains adhering under its own weight.

The dry through volume time is the time period after application of the coating until the film has fully dried through its volume and a pastry wheel run slowly over it no longer causes it to rupture.

The inventive coating composition displays a drying time and pendulum hardness (measured after 15-hour treatment at 60° C.) comparable with that of the prior-art composition.

### Examples 8 to 10

In a further experiment, before the coating was produced, 2,4′-MDI prepolymers were prepared and were compared with a TDI-based prepolymer.

For this purpose 347 g of pure 2,4′-MDI were reacted with 60 g of trimethylolpropane (molar ratio 3:1) in 271 g of butyl acetate (ex. 9) or 407 g of acetone (ex. 10) at room temperature. These prepolymers were then processed with further binders to form a coating composition. The precise constitutions of these compositions are compiled in Table 2. In addition to the substances specified earlier in the text, the following auxiliaries were employed: dispersant Disperbyk®) 110 from BYK (copolymer with acidic groups, 52% strength in methoxypropyl acetate/alkylbenzene), the antisettling and anti-floating agent Bentone® 27 (organic derivative of a magnesium montmorillonite) from Titangesellschaft mbH, titanium dioxide Kronos 2057 from Kronos, abrasive and flatting agent Bärolub® (complex fatty acid amide with an acid number of 10-20) from Bärlocher GmbH, calcium carbonate filler Omyacarb 5 from Omya, magnesia silicate hydrate talc from Omya, inorganic white pigment based on zinc sulfide/barium sulfate, Lithopone D, from Sachtleben Chemie.

TABLE 2

| | 8 | 9 | 10 |
|---|---|---|---|
| Macrynal ® SM636 | 25.00 | 25.00 | 25.00 |
| Disperbyk ® 110 | 0.60 | 0.60 | 0.60 |
| Bentone ® 27 paste, | 3.50 | 3.50 | 3.50 |
| 10% in xylene | | | |
| TiO₂, e.g., Kronos ® 2057 | 19.00 | 19.00 | 19.00 |
| Barolub ® LAK-FG | 1.00 | 1.00 | 1.00 |
| Talkum ® AT1 | 4.00 | 4.00 | 4.00 |
| Omyacarb ® 5 | 9.00 | 9.00 | 9.00 |
| Lithophone ® D | 20.00 | 20.00 | 20.00 |
| Acronal ® 700 L | 0.50 | 0.50 | 0.50 |
| n-Butyl acetate/xylene 2:3 | 17.40 | 17.40 | 17.40 |
| Basonat ® TU67MP/X | 15.50 | | |
| 2,4′-MDI crosslinker, 60% in | | 15.1 | |
| acetone | | | |
| 2,4′-MDI crosslinker, 50% in | | | 31.3 |
| butyl acetate | | | |
| Flow time (DIN 4 mm): | 44 sec | 40 sec | 39 sec |
| Reactivity: | | | |
| Dry to dust (min.) | 7 | 10 | 8 |
| Dry to sand (min.) | 18/21 | 18/18 | 18/15 |
| Dry through volume (min.) | 81/102 | 81/72 | 72/96 |
| Gel time (h) | 8.9 | 11.3 | 12.7 |
| Pd hardness, 15 h, 60° C. | 101/100/102 | 102/102/104 | 100/100/99 |

Basonat ® TU67MP/X (polyfunctional tolylenediisocyanate adduct, as a 67% strength solution in a 1:1 mixture of 1-methoxyprop-2-yl acetate and xylene, having an NCO content of 11.5%-12.3%)

Gel time is the time after which the coating composition has geled in a vessel. It is measured by immersing a welding wire, bent round at a right angle over about 5 mm at one end, into a test tube containing the sample, and moving it up and down in a vertical motion. The gel time is reached when the viscosity of the composition is so high that the wire is no longer able to move freely but instead takes the test tube with it.

Table 2 also depicts the test results. The inventive coatings, 9 and 10, when compared with conventional coating materials based on TDI prepolymers, exhibit comparable pendulum hardness and dry to dust times, with significantly better dry through volume times and potlives.

1-17. (canceled)

18: A coating composition comprising
(a) a mixture of 2,4′-diisocyanatodiphenylmethane (MDI) and 4,4′-diisocyanatodiphenylmethane (MDI), and 2,2′-diisocyanatodiphenylmethane (MDI), comprising the 2,4′-MDI isomer to an extent of at least 90% by weight,
(b) at least one other di- or polyisocyanate,
(c) at least one compound having at least two isocyanate-reactive groups,
(d) at least one further compound having an isocyanate-reactive group,
(e) at least one solvent,
the ratio of isocyanate groups (a) to isocyanate-reactive groups from (c) and (d) amounting (in toto) to less than 1.05:1
and, if at least one compound (b) is present, the ratio of isocyanate groups in (a) and (b) (in toto) to isocyanate-reactive groups from (c) and (d) (in toto) amounting to not more than 1.3:1.

19: The coating composition according to claim 18, wherein component (c) is selected from the group consisting of polyesterols, polyetherols, and polyacrylate polyols.

20: The coating composition according to claim 18, wherein at least part of component (a) is an isocyanate group-containing urethane from the reaction of 2,4′-MDI with at least one n-valent diol or polyol (c1), it being possible for n to adopt values from 2 to 6.

21: The coating composition according to claim 20, wherein n adopts values from 3 to 6.

22: The coating composition according to claim 20, wherein the n-valent diol or polyol (c1) has a molar mass of up to 400 g/mol.

23: The coating composition according to claim 18, wherein at least one component (b) is present.

24: The coating composition according to claim 18, wherein component (a) at least partly comprises monomeric 2,4′-MDI.

25: The coating composition according to claim 18, wherein at least part of component (d) is a polyether alcohol of the formula
R⁵—O—[—Xᵢ—]ₖ—H
in which
R⁵ is as defined above,
k is an integer from 5 to 40, preferably 7 to 45, and more preferably 10 to 40, and
each Xᵢ, independently of one another for i=1 to k, may be selected from the group —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh—O—, and —CHPh—CH₂—O—, preferably from the group —CH₂—CH₂—O—, —CH₂—CH(CH₃)—O—, and —CH(CH₃)—CH₂—O—, and more preferably —CH₂—CH₂—O—
in which Ph is phenyl and Vin is vinyl.

26: The coating composition according to claim 18, wherein at least part of component (d) is a compound of the formula
RG-R³-DG
in which
RG is at least one isocyanate-reactive group,
DG is at least one dispersive group, and
R³ is an aliphatic, cycloaliphatic or aromatic radical comprising 1 to 20 carbon atoms.

27: The coating composition according to claim 18, wherein at least part of component (d) is at least one compound having an isocyanate-reactive group and at least one free-radically polymerizable unsaturated group.

28: The coating composition according to claim 27, wherein at least part of component (d) is 2-hydroxyethyl (meth)acrylate, 2- or 3-hydroxypropyl (meth)acrylate, 1,4-butanediol mono(meth)acrylate, neopentyl glycol mono(meth)acrylate, 1,5-pentanediol mono(meth)acrylate, 1,6-hexanediol mono(meth)acrylate, glycerol di(meth)acrylate, trimethylolpropane monodi(meth)acrylate, pentaerythritol tri(meth)acrylate, and 4-hydroxybutyl vinyl ether, 2-aminoethyl (meth)acrylate, 2-aminopropyl (meth)acrylate, 3-aminopropyl (meth)acrylate, 4-aminobutyl (meth)acrylate, 6-aminohexyl (meth)acrylate, 2-thioethyl (meth)acrylate, 2-aminoethyl(meth)acrylamide, 2-aminopropyl(meth)acrylamide, 3-aminopropyl(meth)acrylamide, 2-hydroxyethyl(meth)acrylamide, 2-hydroxypropyl(meth)acrylamide or 3-hydroxypropyl(meth)acrylamide.

29: A process for preparing a coating composition comprising 2,4′-diisocyanatodiphenylmethane, by
initially introducing a mixture of 2,4′-diisocyanatodiphenylmethane (MDI) and 4,4′-diisocyanatodiphenylmethane (MDI), and, if appropriate, 2,2′-diisocyanatodiphenylmethane, in at least one solvent, and
adding thereto at least one n-valent diol or polyol (c1), n being able to adopt values from 2 to 6, and simultaneously or subsequently adding at least one binder (c2).

30: A method of coating a substrate, which comprises mixing isocyanate group-containing components and the components having isocyanate-reactive groups, and, if appropriate, other, typical coatings additives with one another to give a coating composition according to claim 18 and applying the mixture within a period of not more than 12 hours after mixing to the substrate, and thereafter carrying out drying and curing.

31: The method of using a mixture of 2,4′-diisocyanatodiphenylmethane (MDI) and 4,4′-diisocyanatodiphenylmethane (MDI), and 2,2′-diisocyanatodiphenylmethane, in which the 2,4′-MDI isomer is comprised to an extent of at least 90% by weight, in a coating composition for coating wood, wood veneer, paper, board, card, textile, leather, nonwoven, plastics surfaces, glass, ceramic, mineral building materials, or metals, including coated metals.

32: The method of using a mixture of 2,4′-diisocyanatodiphenylmethane (MDI) and 4,4′-diisocyanatodiphenylmethane (MDI), and, if appropriate, 2,2′-diisocyanatodiphenylmethane, in which the 2,4′-MDI isomer is comprised to an extent of at least 90% by weight, in a transparent coating material for coating paper surfaces or wood surfaces.
